(19) United States
(12) Patent Application Publication
(10) Pub. No.: US 2014/0280281 A1
(43) Pub. Date: Sep. 18, 2014

(54) Formatting in a Database

(71) Applicants: Klaus-Dieter Scherer, Dielheim (DE); Petr Novak, Karlsruhe (DE); Wolfgang Otter, Spechbach (DE); Ivo Vollrath, Waghaeusel (DE)

(72) Inventors: Klaus-Dieter Scherer, Dielheim (DE); Petr Novak, Karlsruhe (DE); Wolfgang Otter, Spechbach (DE); Ivo Vollrath, Waghaeusel (DE)

(21) Appl. No.: 13/844,346

(22) Filed: Mar. 15, 2013

(51) Int. Cl. G06F 17/30

(52) U.S. Cl. CPC G06F 17/30389; G06F 17/30554
USPC 707/759

(57) ABSTRACT

A system and method for formatting in a database are disclosed. A request for data in a database is received from an application. The request includes one or more formatting functions to be performed on the data to display a result of the request in a graphical user interface generated by the application. The formatting functions are executed at the database to restructure the request. A query of the data in the database is then generated based on the restructured request, the query including only data to display in the graphical user interface according to the request. Then, a result of the query is returned from the database to the application for display in the graphical user interface.

### TECHNICAL FIELD

The subject matter described herein relates to databases, and more particularly to formatting of data in a user interface in order to provide more computationally complex processing at the database level and not at the user interface or application.

### BACKGROUND

A list viewer is a tool for a database system that provides services such as sorting, filtering, aggregation, export to a spreadsheet, etc., and which displays the results of those services in a user interface (UI). One such list viewer, called ALV provided by SAP AG of Walldorf Germany, is based on an ABAP “internal table” (ITAB). In early implementations, the UI was a part of the list viewer tool. For example, list viewers such as the SAP GUI ALV and Web Dynpro ALV are implemented in that manner.

This approach has changed however. For instance, the ALV Table Paging for the Business By Design (ByD) suite of products from SAP, and the ATS (for FPM List), follow a new approach in which the UI is implemented separately from the list viewer. For example, the list viewer backend still processes the UI formatting options, but provides only an adequate service framework to generate the UI.

The paradigm of processing one complete internal table has not changed, however a very powerful and reusable component has been introduced: the column catalog. The column catalog is responsible for all kinds of format transformations between internal data representation and the UI representation. The strict separation between data selection and data output has not changed. The column store can be optimally used when the knowledge about UI formatting is available. However, to support new database management systems, this paradigm is not optimal.

Also, functions such as sorting, filtering, grouping and aggregation can be coded into/added to an SQL-Statement.

FIG. 1 illustrates a conventional approach to displaying data using a list viewer tool such as ALV. In the conventional approach, an application 102 performs authorization checks on each row of data 104 in a database 106, and extracts relevant data to an internal table 108. Business data, such as calculated fields, is then added to the contents of the internal table 108. UI information (icons, links, etc.) is also added by the application 102. The internal table is passed to list viewer/table selection (ALV/ATS) services 110, which then manipulate the data 111 according to user requirements. Finally, the required data is displayed according to an external format 112 on the UI 114.

For an end-user, working with huge amounts of data (i.e., millions of records) is often cumbersome and time-consuming. Sorting, filtering, aggregating or searching data could take an extremely long time. Behind the scenes, UI table controls like SAP's GUI ALV required all the data to be first loaded into an internal table in order to be displayed, and then table operations such as sorting, filtering or aggregation were then executed on the internal table. This approach was both time- and memory-consuming for such large amounts of data.

Functions such as sorting can be further complicated based on how data is to be displayed, or whether a conversion is required. For instance, sometimes data is encoded, and needs to be converted from information to a representative code, or vice versa. Codes, as well as icons or other graphics, can sometimes carry special semantics, and proper sorting of codes and icons requires an explicitly given sequence. Or, a display of numerical values such as time or currency may or may not require decimal positions or the precision to the second, respectively.

Filtering, too, has challenges. Comparison operators, i.e. “less/greater than,” as a filter condition make the function much more complex. Filtering by date and/or timestamp can be difficult depending on how data is stored or represented in the database. For instance, there are many different formats for representing a date, and sometimes all of these formats must be considered for proper filtering or other functions.

Accordingly, what is needed is a system and method to execute table operations on the database and to read into memory only what is needed for the UI, in order to conserve both time and memory in the database.

### SUMMARY

In one aspect, a system and method is provided that pushes processing down to the database, and away from the UI. In one aspect, a system includes an application that executes a process to pass the necessary parameters to the database.

In some variations, a method includes receiving a request for data in a database from an application. The request includes one or more formatting functions to be performed on the data to display a result of the request in a graphical user interface generated by the application. The method further includes executing the formatting functions at the database to restructure the request. The method further includes generating a query of the data in the database based on the restructured request, the query including only data to display in the graphical user interface according to the request. The method further includes returning a result of the query from the database to the application for display in the graphical user interface.

In other variations, a computer program product and a system are presented. The system includes at least one programmable processor. The computer program product and system can include a machine-readable medium storing instructions that, when executed by the at least one processor, cause the at least one programmable processor to perform a number of operations. The operations include providing, from an application, a request for data in a database. The request includes one or more formatting functions to be performed on the data to display a result of the request in a graphical user interface generated by the application. The operations further include executing the formatting functions at the database to restructure the request, and generating a query of the data in the database based on the restructured request, the query including only data to display in the graphical user interface according to the request. The operations further include returning a result of the query from the database to the application for display in the graphical user interface.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a process flow diagram illustrating a conventional approach to displaying data using a list viewer tool.

FIG. 2 is a block diagram of a database system employing a list viewer engine.

FIG. 3 is a process flow diagram illustrating displaying data using the list viewer engine.

FIG. 4 is a flowchart of a method for formatting data in a database using the list viewer engine.

When practical, similar reference numbers denote similar structures, features, or elements.

### DETAILED DESCRIPTION

To address these and potentially other issues with currently available solutions, methods, systems, articles of manufacture, and the like consistent with one or more implementations of the current subject matter can, among other possible advantages, provide a mechanism to push necessary parameters to the database.

FIG. 2 illustrates a list viewer engine 202 for a database system 200. The list viewer engine 202 processes requests from an application 206 for data on a database 204 for eventual display on a graphical user interface (GUI) list viewer 206 or other UI 208. The list viewer engine 202 interfaces directly with the database 204, such as an in-memory database. The list viewer engine 202 includes a table service 210 and a column catalog 212 for restricting requests from the application 206, and an SQL generator 214, which maps each restructured request to an application programming interface (API) in the database 204.

The table service 210 performs various services for the SQL generator 214 such as paging and grouping of inputs into a single SQL statement. More specifically, the table service 210 includes user-specified filters from a selection screen in the GUI 206 as provided by the application 206, as well as application 206 specified filters. The table service 210 includes authorization-based restrictions and additional ad-hoc filters. The table service 210 defines sort order, visible rows and/or columns, grouping, aggregation, and lead selection of the data to be displayed in the GUI 206.

The column catalog 212 is configured to translate rules (i.e. sort, filter, grouping, aggregation) into a database request, while considering the formatting options used by the UI 208. Additionally, the column catalog 212 translates a user-specified filter and sort into a database language used by the database 204. Examples of the filter and sort requirements include requesting a time to be displayed without seconds, or amounts grouped by currencies. The column catalog 212 translates codes into descriptions, and vice versa, and ensures that search requests are executed case-insensitively where necessary. Accordingly, the column catalog 212 is configured to handle processing down at the database 204 which had previously been executed by the application 206.

FIG. 3 is a process flow diagram illustrating displaying data using the list viewer engine. Authority checks, table functions, and other processes, normally carried out by an application 304, are performed by a database 302 using a list viewer engine as described above. The application 304 only has to pass the relevant parameters coming from the user or a list viewer engine integrated data access (IDA) in a “where” clause to the database 302. The application 304 handles additional UI information for a UI 306.

Accordingly, the amount of data is severely restricted by the database 302 before it is displayed on the UI 306, and there is no longer a need to store the displayed data inside an internal table. Only that data which is to be displayed on the UI 306 is selected from the database 302, and list viewer-type functions are pushed down to the database 302 to a list viewer engine associated with the database 302.

FIG. 4 is a flowchart of a method 400 for formatting data in a database using the list viewer. At 402, an application creates a list viewer engine, and gives the list viewer engine a name of a database view/table (or more database views combined with join conditions). In some implementations, the application may provide the list viewer engine with required authorizations that have to be checked later when data is read from the database. The application configures a UI with the names of available columns and with formatting options, such as time format or presentation of an internal code, description, etc.

At 404, the application and/or a user of the application defines data selection criteria, and the application provides the data selection criteria to the list viewer engine. When the UI layer needs data for a current displayed page, which can be addressed by a scroll position set by the user, or needs data with particular visible columns as selected by the user, at 406 the UI requests the data from the list viewer engine. In some implementations, and without limitation hereby, the request contains a requested data page (i.e., range of lines), displayed columns, formatting option, and configurations defined optionally by the user. These configurations can include sort order criteria, additional filter criteria, grouping and/or aggregation criteria, among other configuration criteria.

At 408, a column catalog of the database translates the user defined criteria (sort, filter, aggregation, grouping, etc.) into a request that can be executed on the database. Formatting options are reflected in this translation so that the result corresponds to user expectations or input. At 410, the list viewer engine creates a database request by combining information from various sources. These sources can include, as examples and without limitation: data selection criteria and authorizations received from the application in steps 402 and 404 described above; visible columns received from the UI in step 406; and database criteria received from the column catalog in step 408. The list viewer engine sends the database request to the SQL generator. This request is in a database-independent, structured format. The term structured as used here means that the request is stored as an ABAP structure where each component has its own semantic.

At 412, the SQL generator generates a database-specific SQL text string out of the structured request. The SQL generator executes the SQL query on the database, and transports result data from the database to the list viewer engine. Accordingly, any database can execute these functions and features if a corresponding database-specific SQL generator is available.

At 414, if the application requires or needs additional UI relevant data, the list viewer engine asks the application to extend the data and/or page with the additional UI relevant data. At 416, the list viewer engine sends the result to the UI layer for the UI. In a case where the user scrolls, changes data selection or changes the criteria (sort . . . ) within the UI, the method 400 can be restarted from 404 or 406.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving a request for data in a database from an application, the request including one or more formatting functions to be performed on the data to display a result of the request in a graphical user interface generated by the application;
executing the formatting functions at the database to restructure the request;
generating a query of the data in the database based on the restructured request, the query including only data to display in the graphical user interface according to the request;
returning a result of the query from the database to the application for display in the graphical user interface.

2. The method in accordance with claim 1, wherein the one or more processing functions includes at least one of filtering, sorting, grouping, and/or aggregating of the data in the database.

3. The method in accordance with claim 1, wherein executing the processing functions at the database further includes executing one or more filters specified by the application prior to receiving the request.

4. The method in accordance with claim 3, wherein the one or more filters includes one or more data formatting specifications.

5. The method in accordance with claim 3, wherein the one or more filters includes one or more code translation specifications.

6. A computer program product comprising a machine-readable medium storing instructions that, when executed by at least one programmable processor, cause the at least one programmable processor to perform operations comprising:
providing, from an application, a request for data in a database, the request including one or more formatting functions to be performed on the data to display a result of the request in a graphical user interface generated by the application;
executing the formatting functions at the database to restructure the request;
generating a query of the data in the database based on the restructured request, the query including only data to display in the graphical user interface according to the request;
returning a result of the query from the database to the application for display in the graphical user interface.

7. The computer program product in accordance with claim 6, wherein the one or more processing functions includes at least one of filtering, sorting, grouping, and/or aggregating of the data in the database.

8. The computer program product in accordance with claim 6, wherein the operations include executing one or more filters specified by the application prior to receiving the request.

9. The computer program product in accordance with claim 8, wherein the one or more filters includes one or more data formatting specifications.

10. The computer program product in accordance with claim 8, wherein the one or more filters includes one or more code translation specifications.

11. A system comprising:
at least one programmable processor; and
a machine-readable medium storing instructions that, when executed by the at least one processor, cause the at least one programmable processor to perform operations comprising:
provide, from an application, a request for data in a database, the request including one or more formatting functions to be performed on the data to display a result of the request in a graphical user interface generated by the application;
execute the formatting functions at the database to restructure the request;
generate a query of the data in the database based on the restructured request, the query including only data to display in the graphical user interface according to the request;
return a result of the query from the database to the application for display in the graphical user interface.

12. The system in accordance with claim 11, wherein the one or more processing functions includes at least one of filtering, sorting, grouping, and/or aggregating of the data in the database.

13. The system in accordance with claim 11, wherein the operations include executing one or more filters specified by the application prior to receiving the request.

14. The system in accordance with claim 13, wherein the one or more filters includes one or more data formatting specifications.

15. The system in accordance with claim 13, wherein the one or more filters includes one or more code translation specifications.
